(19) United States
(12) Patent Application Publication
(10) Pub. No.: US 2011/0051268 A1
(43) Pub. Date: Mar. 3, 2011

(54) BLIND SPOT MIRROR

(76) Inventor: PATRICK MARTIN, BELMONT, MI (US)

(21) Appl. No.: 12/553,751

(22) Filed: Sep. 3, 2009

(51) Int. Cl. B60R 1/08; G02B 7/185

(52) U.S. Cl. 359/846; 359/865

(57) ABSTRACT

A new blind spot mirror comprising a bifurcated mirror, allows one portion of a mirror to remain in the normal driving mode while concurrently allowing a blind spot portion to be transitioned to a position where the blind spot area can be viewed. The transition from regular viewing to blind spot viewing can be triggered by manual and/or automatic means. An alternate embodiment of the present invention comprises a mirror assembly with one mirror face affixed back-to-back with another mirror face. One face is used for normal driving mode and the other face is angled to capture the blind spot area. Transition (rotation) of the blind spot mirror face into viewing position may be triggered by manual or automatic means.

In another embodiment of the invention, a flexible mirror face is included over the mirror portion and the blind spot portion to disguise the parting between the two portions.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to mirrors for use with motor vehicles. More particularly, the present invention relates to a so-called blind spot mirror that compensates for the otherwise limited viewing of a driver in a rear view mirror by automatically adjusting for viewing of a position in the blind spot of a driver during operation of the motor vehicle.

Many automotive mirror products have been manufactured or proposed, where the mirror is able to adjust for and provide a view of the blind spot while the driver is operating the vehicle. The motive for such a product is entirely clear, the potential for collisions is very great when lane changing and the chief cause is the natural lack of visibility that the driver has for the area in the vicinity of the rear quarters of the vehicle. This so-called “blind spot area” will vary with each vehicle and with the characteristics of each driver, however it is generally understood that the limitations of the mirror to view something less than 100% of the area behind the car in a factor can be aggravated by obstructions owing to the design of the car, the size of the driver, and the driver's own capabilities when it comes to peripheral vision. While normal viewing through a rear view mirror provides ample visibility of the area immediately behind the vehicle, it is not normally possible to cover both this area and the blind spot territory without resort to some sort of mirror adjustment.

Adjusting type blind spot mirrors in the prior art are known and include versions that cause the mirror to move in response to a signal, typically a turn signal, where the mirror automatically adjusts to a blind spot position and then after a momentary pause or upon the cessation of the triggering signal, returns automatically to the normal driving position. The intent is to allow the driver a chance to view the blind spot area before he or she transitions into the left lane. The prior art devices accomplish this in many ways, including making use of the pre-existing drive mechanisms for power adjusting mirrors. Using a servomechanism or a drive with digital encoding capabilities allows the mirror to move from an adjusted position to the blind spot position and then return with precision to the original adjusted position.

In some instances, the blind spot mirrors of the prior art may be triggered by sensors that detect the presence of a vehicle at points to the rear of driver. The actual sensor employed is not important with respect to the present invention, but as will be seen below, it illustrates yet another means for triggering the action of the present mirror to allow a view of the blind spot area.

Lastly, there is always a manual trigger that can generate the blind spot action in the prior art mirrors. In some cases this is nothing more than mechanically causing the mirror to shift from the normal driving position. The driver can use a lever to shift the angle of the mirror, analogous to the mechanism for an interior day-night rear view mirror.

The prior art presents some difficulties in use. For instance, wholesale shifting of the mirror lens means that the view in the mirror is committed to either the regular driving position or the blind spot position. Also, the shifting process typically eliminates viewing altogether though this may last only for a moment. The shifting process has the potential for being disorienting and may not promote the safe execution of lane changes. Another drawback in some of the prior art devices is the precision in returning to the original driving position. Since the mirrors are typically adjusted by each driver to fit their individual viewing perspective, the return to this position is highly desirable and not always achieved when the mechanism cannot gauge the shift changes accurately.

The present invention has advantages over the prior art devices with attributes that are believed to promote the safe use of a blind spot mirror of this type. These features and attributes will be more completely discussed below.

### SUMMARY OF THE INVENTION

A blind spot mirror in accordance with the present invention comprises a mirror portion housed inside a mirror body, where the mirror portion has an outer portion that is adjustable between a normal viewing position and a blind spot position. The outer portion is a fraction of the overall mirror portion and is able to be independently actuated to an angular position while the remainder of the mirror portion, the inner portion, remains in place.

The actuation of the present invention may be triggered manually or automatically. The outer mirror portion then moves to the blind spot position leaving the balance of the mirror portion in the same viewing position.

In another embodiment of the present invention, the mirror portion comprises a flexible mirror surface that can be actuated to a position where a portion of the mirror surface is contorted to an angular position that is calculated to address the viewing of the blind spot of the driver.

The blind spot mirror of the alternate embodiment can be actuated manually or automatically.

### BRIEF DESCRIPTION OF THE DRAWINGS

FIG. 1 is a perspective view of a conventional mirror for a motor vehicle shown as mounted on the motor vehicle.

FIG. 2 is a perspective view of a mirror of the present invention.

FIG. 3 is a side elevational view of the mirror of FIG. 2, shown with connections to a sensor for sensing the proximity of an advancing motor vehicle.

FIG. 4 is a top view of a car with a conventional mirror showing an advancing motor vehicle.

FIG. 5 is a top view as in FIG. 4, with a car employing the mirror of the present invention, with a sensing means being activated to by the advancing motor vehicle and thereby deploying the blind spot mirror function.

FIG. 6 is a cross sectional view of a mirror of the present invention revealing an embodiment that utilizes a mirror with two glass portions and in the normal at-rest position.

FIG. 7 is a cross sectional view of the mirror of FIG. 6 showing the mirror in the blind spot position.

FIG. 8 is a top view representation of the mirror glass portions of the mirror of FIG. 6, showing the angle of reflection designated as “A” realized by an observer represented by the viewer's eye.

FIG. 9 is a top view representation of the mirror glass portions of the mirror of FIG. 6 and as deployed in the blind spot position as shown in FIG. 7.

FIG. 10 is a top view of an alternate embodiment of the mirror of the present invention showing the mirror with a flexible mirror surface and in the at rest position.

FIG. 11 is a top view of the mirror of FIG. 10, showing the mirror in the blind spot position.

FIG. 12 is a cross-sectional view of the mirror of the alternate embodiment, showing the mirror in the normal driving (at rest) position.

FIG. 13 is a top cross-sectional view of the embodiment shown in FIG. 12 with the mirror oriented in the blind spot position.

FIG. 14 is a perspective view of a mirror of the alternate embodiment, showing the mirror surface as it would appear in the normal driving (at rest) position.

FIG. 15 is a perspective view of the mirror of the alternate embodiment, showing the mirror surface as it would appear in the blind spot position.

### DETAILED DESCRIPTION OF THE PREFERRED EMBODIMENTS

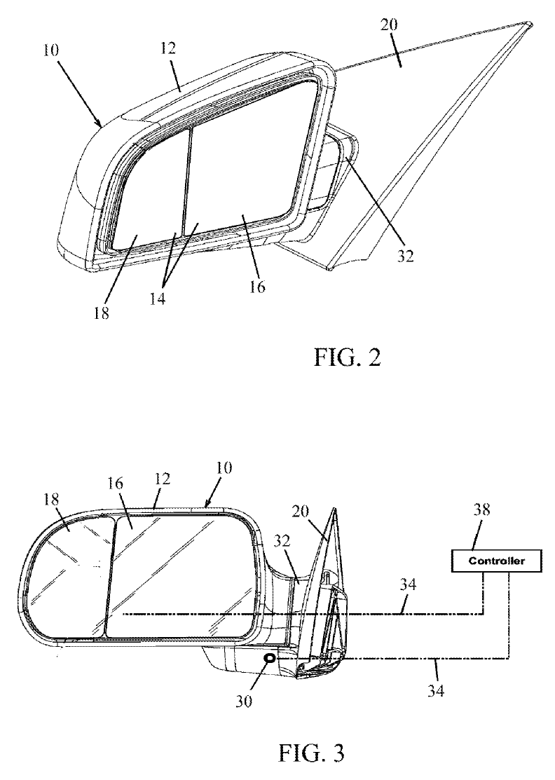

A new mirror for viewing blind spots while driving a motor vehicle is shown in FIG. 2. As may be seen, the present invention is cosmetically similar to the conventional mirrors used in motor vehicle applications and would, for the most part, be indistinguishable from the usual mirror fixtures when viewed by the average person. The function of the present invention is very different, however, from the conventional mirror for a motor vehicle. It is understood herein, that the terms “motor vehicle” or “automobile” or just “vehicle” and the like are interchangeable and are meant to include all applications where a mirror may be used to assist in the operation or driving of a device. This could include applications as usual and customary as passenger cars or trucks, and it could also include commercial or industrial uses such as delivery vans, lift trucks, or tractors, for example and could even extend to military type vehicles such as tanks or troop carriers.

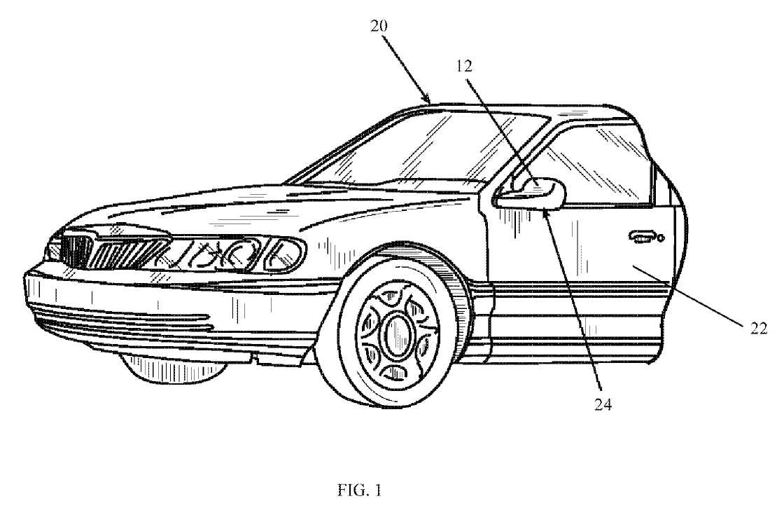

A conventional mirror 24, as shown in FIG. 1 includes the body 12 is installed on motor vehicle 20 by mounting the mirror 24 onto the door 22. In FIGS. 2 and 3, the mirror 10 of the present invention is shown with mirror portion 14, the inner mirror portion 16, the outer mirror portion 18, the motor vehicle 20, and the mirror mounting 32. In FIG. 3, the sensor 30 is also seen with is also visible with sensor leads 34, mirror leads 36 and a relay/controller 38. This mirror illustrates the first embodiment of the present invention where the mirror portion 14 is bifurcated between the inner mirror portion 16 and the outer mirror portion 18. The mirror as shown may be manually adjusted for overall viewing or it may be fitted for remote adjusting through the use of cable or electronic controls, servo drives and digital encoders among other devices. It is not a part of the present invention to show all types of drives or means for making the gross adjustments to the mirror, it suffices to know that various methods exist and one skilled in the art can easily match up the teachings of the present invention to the control or drive system of choice.

A conventional mirror will usually allow for adjustment vertically and horizontally at a pivot point. The mirror portion of the conventional mirror moves within the enclosure for this purpose and encompasses enough of an adjustment range to handle the rear vision requirements for virtually all drivers of motor vehicles. However, it is a given that once the conventional mirror has been adjusted, it is desirable to not affect this adjusted position while the vehicle is in operation. For instance, if the driver was attempting to manually adjust the mirror to view the blind spot area this action could distract him/her from safely managing the travel of the vehicle. Then there is the reverse problem of re-adjusting the mirror once the view of the blind spot area has been obtained. Thus it is desirable to have some means included in the conventional mirror for blind spot functions that can be obtained without having the driver intervene.

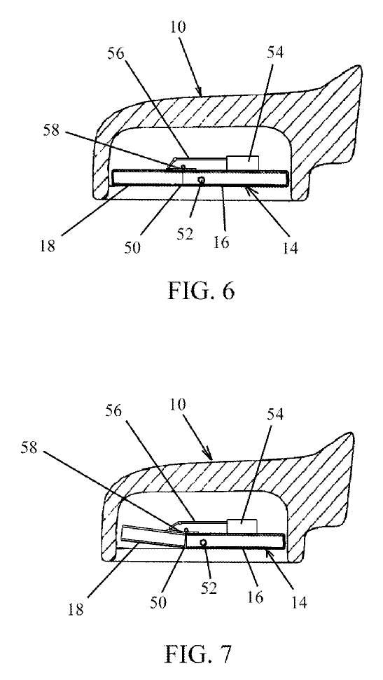

The blind spot mirror 10 of the present invention is shown initially in FIGS. 2 and 3. In FIGS. 6, 7, 8, and 9 the initial embodiment of the present invention is shown with the bifurcated mirror portion 14 and includes the parting 50 can be seen to divide the mirror portion 14 into two unequal parts, and which correspond to the inner mirror portion 16 and the outer mirror portion 18. Other than the appearance of a line at the parting 50, the mirror of the present embodiment resembles a conventional mirror, although as will be seen, the it function quite differently.

FIGS. 6 and 7 reveal components that act behind the mirror face and which include the pivot 52, the solenoid 54, the solenoid arm 56 and the hinge 58. In FIG. 6 the mirror is in the normal driving position or the “at rest” position, while in FIG. 7 the mirror is shown with outer mirror portion 18 angled as it sits within the mirror body 12 and this comprises the deployed or blind spot position. The mirror face, that is the surface of the mirror portion 14, is bifurcated into the inner mirror portion 16 and the outer mirror portion 18 in this position, which is the orientation that allows for blind spot vision by the driver of the motor vehicle.

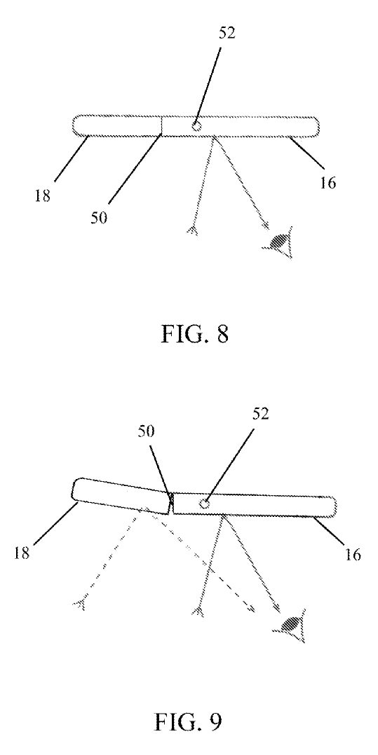

The outward appearance of the mirror does change slightly as a result of the changed position to a blind spot view as can be seen in the differences between FIG. 6 and FIG. 7 and also as can be seen in FIGS. 8 and 9. The parting 50 is more pronounced as a result of the angling of the outer mirror portion, although the mirror face as a whole looks nearly the same as in the normal driving position. The inner mirror portion 16 which has a little more surface area than the outer mirror portion 18 and since the inner mirror portion remains in the same position; for the most part it is an accurate observation to note the “sameness” in appearance.

The action that generates the movement to the new position by the outer mirror portion comes from one of many possible sources. As shown in this embodiment, a solenoid is used to actuate the change which is an operation that is well known in the art. The representation is merely meant to show that any sort of drive mechanism can be used to control the mirror portion and to cause the outer mirror portion to move from the at rest position to the blind spot position at the desired time and condition. Many other controls or drivers could be used by one skilled in the art to accomplish the movement operation necessary to position the outer mirror portion in the blind spot orientation.

As can be seen in FIGS. 8 and 9, the present invention allows for a novel result from a single mirror. The points identified as “A” and “B” in the two drawings represent the normal driver's view and the blind spot view respectively. In FIG. 8, the viewer (represented by the eyeball-looking symbol) is able to read the same angle of reflection across the whole surface (face) of the mirror portion 14 as would be the case for a conventional mirror. This is the case even though there is a parting 52 which separates the mirror portion into two unequal parts, the inner mirror portion 16 and the outer mirror portion 18. The viewer has adjusted the mirror to the appropriate position for normal driving requirements, by positioning the mirror through the use of the pivot 52, and this perspective is the one that remains viewable across the whole mirror face.

In FIG. 9 we can see that the outer mirror portion 18 has moved to a different position, the blind spot position, one that is a more pronounced angle as compared to the inner mirror portion 16. Now the driver is able to view both the blind spot area (represented by “B”) and the normal driving view (represented by “A”) at the same time. In use, the blind spot angle may be predetermined and then fixed in relation to the inner mirror portion. In this way, the driver remains free to adjust their mirror for the appropriate normal viewing position and the whole mirror will remain in this position until and unless the blind spot mechanism is activated. Once done, activation of the blind spot feature results in the outer mirror portion moving to the blind spot position as shown.

It may now be appreciated that in use, the vehicle driver may actuate or trigger the blind spot viewing function through one of several possible means. One that is intuitively appropriate is through the use of the left turn signal which usually coincides with the need to check the blind spot when attempting any movement of the vehicle into a left lane or for a left turn. The activation of a driving means such as a solenoid would result in the immediate transition of the outer mirror portion to the blind spot position, the angle of which has previously been calculated, and once the turn signal has been deactivated, then the outer mirror portion returns to the normal driving view, or the at rest position. The advantage in this comes from the fact that only a part of the overall mirror function is disrupted, leaving the driver with sufficient visibility as to events happening behind the vehicle to avoid any problems. However, the automatic shifting of the outer mirror portion to the blind spot increases the range of vision to the driver selectively to allow the driver to check and see if indeed there is another vehicle in the blind spot area and then to take the action necessary once that information has been obtained.

In the preferred embodiment, the transition between the at rest position and the blind spot position occurs through the use of a sensing means such as that shown in FIG. 3. A rearward looking sensor can be used to determine whether or not a motor vehicle is advancing from the rear and into the blind spot area. This sensor may be a laser detector, an ultrasonic detector, a radar detector, or similar type, such that it typically broadcasts a signal that is reflected off the mass of the approaching motor vehicle and is then picked up by the sensor. This returned signal, once detected, triggers the mirror to transition to the blind spot position. The benefits of this approach are many and include the automatic functioning of the present invention without the need to manually trigger the function through the use of the turn signal. The type of actual detector used is not important to the present invention so long as it fulfills the requirements for use in triggering the response.

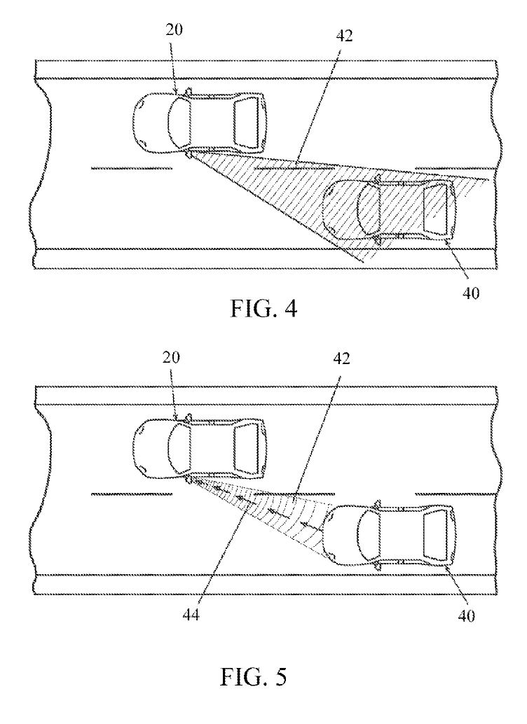

Turning now to FIGS. 4 and 5, the usage of the sensing system can be disclosed in more detail. In FIG. 4, the advancing motor vehicle 40 is shown and enters the zone 42 in which it may be viewed by the mirror. The problem is that the mirror cannot view all of the zone at one time and blind spots exist that prevent the user/driver from seeing the advancing motor vehicle. The functioning of the present invention allows the mirror to encompass all of the zone, or substantially all of the zone and give the user/driver the needed information about the presence and position of the advancing motor vehicle. Further, as shown in FIG. 5, the sensing mode, when deployed, sends a signal that is reflected at 44 and which in turns sets into motion the transition of the mirror to the blind spot position.

This embodiment of the present invention is not limited to any other particular activation method or scheme; it would certainly be desired to have a manual activation, notwithstanding any other concurrently installed method, so that the driver can initiate a check of the blind spot at any time. It is preferable in some respects to do this before the turn signal switch is thrown since the appearance of another vehicle in the blind spot would obviate the need for any signaling at all. This would reduce the potential for confusion and make it less likely for an accident to result.

As mentioned previously, the compactness of the present embodiment lends itself to installation within the standard mirror housings and for integration with the standard mirror mechanisms. To this end, the normal adjustment mechanism for the mirror remains intact, and the mirror is free to be adjusted in vertical and horizontal directions. The present invention can also be integrated into other mirror devices including those with drive or control systems. In cases such as this, separate drives or controls may be needed to operate the outer mirror portion, but the concept and the advantages of the present embodiment would remain essentially intact.

It is important to note that the use of a bifurcated mirror face allows for improved safety for the driver (and others) since the field of vision relative to the normal view in mirror is still available. The transition of the outer mirror portion to the blind spot position can be engineered to be quick or it can be made to last for some specified duration. When the mirror is used with a sensing system, the mirror remains deployed in the blind spot position during the length of time that the advancing motor vehicle is approaching and preferably, for a set period of time thereafter. In cases where the driver may be engaged in heavy traffic, it may be preferable to keep the outer mirror portion in the blind spot position to ensure against the possible collision when changing lanes on short notice or similar.

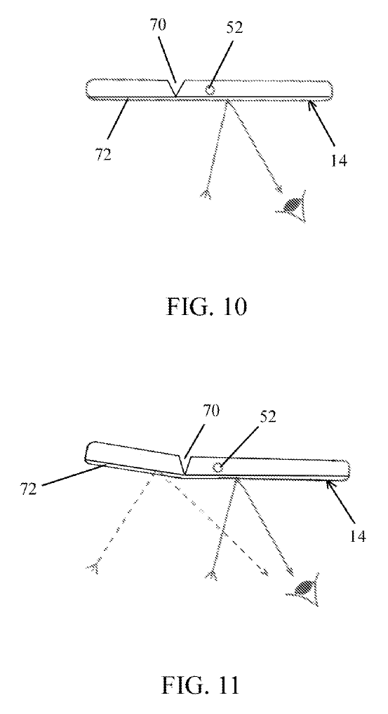

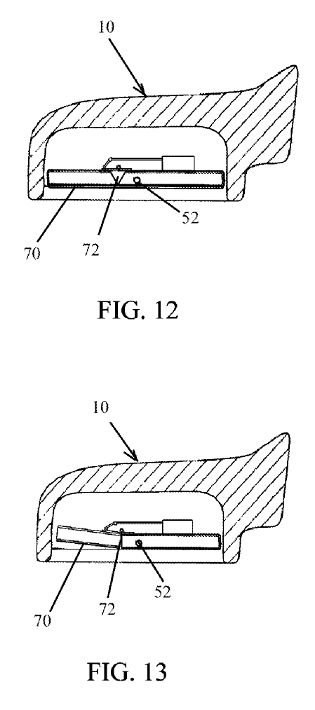

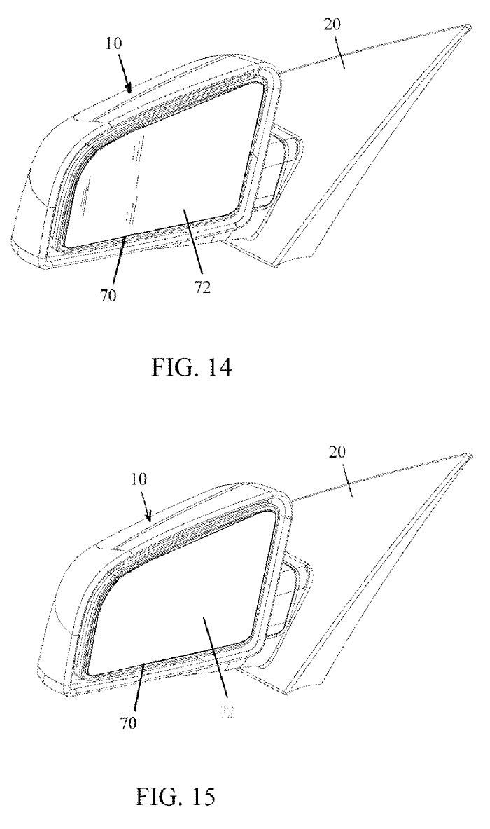

An alternate embodiment of the present invention is shown in FIGS. 10, 11, 12, 13. 14 and 15. In these views the mirror portion 14 has a continuous mirror face 72 and a parting 70 that is hidden behind. The functioning of this embodiment is essentially identical to the prior embodiment except that the mirror face is contorted and never reveals any parting line to the user. In this manner, the mirror of the present invention does not appear any different whatsoever as compared to a conventional mirror. The mirror face is comprised of a plastic that has been formulated with a mirror surface and that is flexible at least in the area of the parting. Thus the plastic can repeatedly bend at this point without breaking and maintains a continuous appearance.

As was the case with the prior embodiment, the blind spot function may be activated by an automatic trigger such as a turn signal switch or by means of a sensing system. Upon cessation of the activating signal, the mirror face return to at rest driving mode. The mechanism used to drive the mirror face during the transition is not specifically shown and it is left for one skilled in the art to apply the desired drive or control mechanism, whether this is a servo drive, or a solenoid or whatever is compatible with the objectives and functions of the present embodiment.

Also like the previous embodiment, the mirror is typically adjusted to meet the requirements of the driver. One advantage to the present invention is the fact that the driver never has to readjust the regular mirror face positioning, except as he would normally. There is no reliance on drivers or servos to re-set the mirror positions in the correct way since the regular mirror face adjustment is never altered.

The illustrations of the present invention through the embodiments discussed above are meant to be illustrations and not limitations. The scope of the present invention is anticipated to be as broad as possible within the confines of the teachings of the concept.

1. A rear view mirror for a vehicle, capable of selectively viewing a blind spot area, comprising;
A mirror portion that is bifurcated between a part of said mirror portion reversibly moveable between a normal viewing position and a blind spot viewing position, and another part of said mirror portion that remains in a normal viewing position;
A trigger, subject to activation, for initiating the movement of a part of said mirror portion from a normal viewing position to a blind spot viewing position; and,
A driver for driving a part of said mirror portion from a normal viewing position to a blind spot viewing.

2. The mirror as in claim 1, where deactivation of said trigger allows said mirror portion to return to a normal viewing position from a blind spot viewing position.

3. The mirror as in claim 1, where said trigger is activated manually.

4. The mirror as in claim 1, where said trigger is activated automatically.

5. The mirror as in claim 1 where the mirror portion includes a flexible mirror face.

6. A rear view mirror for a vehicle, capable of selectively viewing a blind spot area, comprising;
A mirror portion that is bifurcated between a part of said mirror portion moveable between a normal viewing position and a blind spot viewing position, and another part of said mirror portion that remains in a normal viewing position;
A trigger, subject to activation, for initiating the movement of a part of said mirror portion from a normal viewing position to a blind spot viewing position, and where once said trigger is deactivated allowing said part of said mirror portion to return to a normal viewing position from a blind spot viewing position;
A driver for driving said part of the mirror portion from a normal viewing position to a blind spot viewing position.

7. The mirror as in claim 6, where said driver is comprised of a solenoid or a servomechanism.

8. The mirror as in claim 6 where the mirror portion includes a flexible mirror face.

9. A rear view mirror for a vehicle capable of selectively viewing a blind spot area, comprising;
A mirror assembly comprising a regular face and a blind spot face, where said mirror assembly is rotatably connected to a mirror body, allowing said regular face to be displayed to the operator of the vehicle, or in the alternate said blind spot face to be displayed to the operator of the vehicle;
A drive for rotating said mirror assembly between a regular viewing position and a blind spot viewing position;
A trigger, subject to activation, causing said drive to rotate said mirror assembly.

10. The mirror as in claim 9, where said trigger is subject to repeated activations causing said mirror assembly to rotate to a new viewing position upon each of such activations.

11. The mirror as in claim 9, where said trigger is activated manually.

12. The mirror as in claim 9, where said trigger is activated automatically.

13. The mirror as in claim 9 where the mirror portion includes a flexible mirror face.
